(19) United States
(12) Patent Application Publication
(10) Pub. No.: US 2015/0046369 A1
(43) Pub. Date: Feb. 12, 2015

(54) DOCUMENT GENERATION, INTERPRETATION, AND ADMINISTRATION SYSTEM WITH BUILT IN WORKFLOWS AND ANALYTICS

(71) Applicant: AXIOM GLOBAL INC., New York, NY (US)

(72) Inventors: James TAYLOR, Waxhaw, NC (US); Russel MCNEIL, Glasgow (GB); John EDWARDS, Nashville, TN (US); Robert COUCH, San Ramon, CA (US); Andrew OZENNE, Houston, TX (US); Frederick TEAGUE, New Providence, NJ (US); Russell ZIMPRICH, Mooresville, NC (US); Robyn SWEET, Laguna Niguel, CA (US); Mark HARRIS, Mill Valley, CA (US); Jake RICCIARDI, New York, NY (US); Mark TREPANIER, Wrightsville Beach, NC (US)

(21) Appl. No.: 14/455,426

(22) Filed: Aug. 8, 2014

Related U.S. Application Data
(60) Provisional application No. 61/864,232, filed on Aug. 9, 2013.

(51) Int. Cl. G06Q 10/10

(52) U.S. Cl. CPC G06Q 10/10
USPC 705/342

(57) ABSTRACT

A document generation, interpretation, and administration system and method and a workflow management system with analytics are provided. The system and method are designed to manage a document process from inception through closure, including all follow-up tasks. The system and method include a portal or network having a data model for storing detailed data relating to draft and finalized documents. The data model is used to track pending and executed agreements, and to track manage specific agreement commitments and commitment triggering events to ensure that each agreement commitment is met. The system is capable of managing detailed agreements and numerous commitment types including financial and non-financial commitments. The system may also be used to generate correspondence and invoices as are necessary to meet various agreement commitments.

### RELATED APPLICATION

This application claims the benefit of U.S. Patent Application Ser. No. 61/864,232, filed Aug. 9, 2013, which is incorporated herein by reference.

### BACKGROUND OF THE DISCLOSURE

1. Field of the Disclosure

This disclosure relates to a holistic legal, document, and commitment adherence services solution built on a purpose data model and core engine addressing banking, financial, insurance, medical, and technology industries. The core engine powers a complete legal services lifecycle solution inclusive of creation of request for legal support, document generation, interpretation and extraction, negotiation and execution, commitment and adherence management, and workflow. The core engine incorporates technical abilities eliminating additional development efforts in providing visibility through user selected self-service interfaces including a portal, a ribbon, or mobile devices. Further, the solution provides increased visibility, collaboration and quantification to address substantive legal concerns or to determine the underlying risk during a negotiation or to analyze risk across previously executed contracts. Additional visibility is also provided through dynamic analytics incorporating client data through self-service selection.

2. Discussion of Background Art

A framework can be developed for legal, document, banking compliance, and regulatory compliance services for conducting business. This framework will be founded upon documents or the analysis of a document set. Many businesses today, particularly large corporations, are party to hundreds, perhaps thousands, of documents, each, by definition, granting various rights, containing inherent risk(s) while creating various commitments. Keeping track of the mere existence of every document, understanding the associated risk with that document and ensuring adherence with the various rights and commitments they create, presents an enormous challenge.

Additional problems arise during document drafting and negotiation. Even simple documents often go through a number of drafts before agreement is reached. The process of negotiation and document review and approval, both among and between parties, to a proposed document is often a complex process during which it is difficult to keep track of various draft versions and approvals.

Further, the quantification and visibility into substantive legal concerns and risk can be lost due to the focus on throughput and speed to closure. The result which plagues the current legal services environment is non-adherence to pre-defined playbooks including contractual templates, clause libraries and legal positions, while introducing and increasing risk throughout the lifecycle of legal services.

Existing software solutions, networks and databases have been created to meet some of these challenges. These products, or point solutions, however, typically address problems associated with one particular business operation's perspective of a document's lifecycle. While newer entries into the legal services market have capabilities to provide software for managing various aspects of document compliance, these do not address all of the administration and management needs that arise during the entire legal services lifecycle. These solutions are also very focused on throughput and speed sometimes to the detriment of minimizing risk and adherence to company compliance.

There is a need for complete legal service lifecycle solutions, document generation, interpretation and extraction, risk avoidance, negotiation and execution, commitment and adherence management, workflow, visibility to the underlying data through analytics, and user interfaces that drives adoptions and behaviors.

### SUMMARY OF THE DISCLOSURE

The present disclosure provides a holistic legal, document, risk avoidance and commitment adherence services solution built on a purpose data model and core engine covering, but not limited to, banking, financial, insurance, medical, and technology industries. The core engine powers a complete legal services lifecycle solution inclusive of document generation, interpretation and extraction, risk avoidance, negotiation and execution, commitment and adherence management. The solution provides increased visibility, collaboration and quantification to address substantive legal concerns via user selected self-service interfaces, including but not limited to, a portal, a ribbon, or mobile devices. Visibility is also provided through dynamic analytics incorporating client data through self-service selection.

In an embodiment, the present disclosure provides a document generation, interpretation, extraction, negotiation, execution, risk avoidance, commitment, adherence, and administration system with built in workflows and analytics that spans the lifecycle of a document. This system employs a suite of applications configured to provide complete integrated document delivery. The suite of applications comprise a core or underlying data model, modules (i.e., integrated document delivery modules, business intelligence modules, service delivery modules, cross solution modules, solution extension/add-on modules and platform modules), a ribbon, a portal and an annex for client data incorporated into client specific analytics.

The core or underlying data model (e.g., integrated document delivery modules) supports document creation, and interpretation and extraction, collection of key document information, and commitments associated with executed documents. The core or underlying data model also includes advance workflow and knowledge management, and is the central location for security and user administration. The core or underlying data model also includes the ability to assign risks to individual data elements or clauses utilized on both document creation and post execution analysis. This unique capability provides the user an insight into the underlining risk inherent in any contract negotiation, advising the user on alternative positions that can be taken to reduce the risk, and simplifying and speeding up approval decisions by providing an easily-understood quantification of overall risk in a contract. This data model can be extended to analyze the risk that is inherent in a group of documents that have previously been executed. The data module is referred to as iRisk.

The modules (i.e., integrated document delivery modules, business intelligence modules, service delivery modules, cross solution modules, solution extension/add-on modules and platform modules) support the functions of the core or underlying data model as described herein. The modules are integrated into the overall workflow management and document generation and administration system of this disclosure.

The ribbon (e.g., Microsoft Ribbon) allows users to interact with the core providing the ability to create standard templates, facilitates the drafting of documents, assists in the negotiation of documents, informs on the current risk inherent in the current version of the document, manages the qualification/categorization of terms (provisions/elements), and additionally, other core functions supporting these abilities.

The request portal is a browser based solution that allows casual users to interact with the core or underlying data model, including initiating requests and tracking progression of requests.

The client portal is a browser based solution that allows casual users to interact with the core or underlying data model, including to initiate requests, self-service document generation, track progression of requests, visibility into the document's negotiation process, respond to alerts, approvals, and escalations, initiate and view searches, reports, and analytics, and respond to commitments.

The annex is comprised of offline databases that provide mechanisms which allow migration of legacy document data, terms, language, conditions, and attachments, and client operation data for the purposes of search and retrieval and client specific analytics.

In accordance with this disclosure, integrated document service delivery modules are integrated into the overall workflow management and document generation and administration system. The integrated document service delivery modules comprise document creation modules, document information modules and contract commitment modules. The document creation and execution modules are configured to manage document requests from a client, preparation of documents, management of negotiations of documents, interpret and extract versioned drafts, dynamically analyze negotiated drafts, qa and finalize documents and execute contract documents. The document information modules are configured to collect executed contracts, file contracts, interpret and extract key metadata associated with the document, and monitor documents. The document commitment adherence modules are configured to register document commitments, assess document commitments, monitor commitments, and manage commitment adherence.

In accordance with this disclosure, iRisk is a browser based solution that allows users to determine the underlying risk in any document as a result of answering a series of questions designed to derive a risk evaluation. The evaluation is derived by examining the deviation from standard, critical meta data values and the correlation that exists between critical meta data and clauses.

In accordance with this disclosure, service delivery modules are integrated into the overall workflow management and document generation and administration system. The service delivery modules are configured to provide administration tools for activation and delivery team productivity in setup and deployment, operational reporting and analytics for visibility into internal operations, an overall view of client team productivity, and a view into and manage service and change requests.

Also, in accordance with this disclosure, business intelligence modules are integrated into the overall workflow management and document generation and administration system. The business intelligence modules are configured for process analytics, performance analytics, document analytics, commercial analytics, commitment analytics, adherence analytics, risk analytics, and substantive legal analytics.

Further, in accordance with this disclosure, cross solution modules are integrated into the overall workflow management and document generation and administration system. The cross solution modules are configured to manage submitted requests, their related process activities and related workload, interpret and extract document content and manage documents, assess risk and manage library content including templates, clauses, playbooks, and knowledge.

Yet further, in accordance with this disclosure, solution extension/add-on modules are integrated into the overall workflow management and document generation and administration system. The solution extension/add-on modules provide connectivity to various commercially available tools, external processes, or specific client applications. The solution extension/add-on modules also provide mobilization and secure collaboration.

The aforementioned modules are built with the guiding principles of driving substantive legal decision and proper business behaviors, both directly correlated to the mitigation of risk through the provisioning of proper visibility, collaboration and decision guidance.

The platform modules are configured to support users administration including authentication and entitlement and for remote access, globalization and document data engines.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 depicts the modules or functional components of the system of the present disclosure.

### DESCRIPTION OF THE EMBODIMENTS

As used herein, the term “portal” is defined to mean a website that brings information together from diverse sources in a uniform way. Typically, each information source gets its dedicated area on the page for displaying information (i.e., a portal). Often, the user can configure which ones to display. Apart from the standard search engines feature, portals offer other services such as data models, information, e-mail, news, stock prices, entertainment, and the like. Portals provide a way for enterprises to provide a consistent look and feel with access control and procedures for multiple applications and data models, which otherwise would have been different entities altogether.

As used herein, the term “mobilization” is defined to mean a delivery model in which software and associated data is readily available on mobile devices (i.e. smartphones, PDAs, tablets, or other internet capable devices). Mobilization in the software sector has become a common delivery model for many business applications, including office & messaging software, DBMS software, management software, CAD software, development software, gamification, virtualization, accounting, collaboration, customer relationship management (CRM), management information systems (MIS), enterprise resource planning (ERP), invoicing, human resource management (HRM), content management (CM) and service desk management. The term “mobilization” is considered to be part of the nomenclature of cloud computing.

As used herein, “core” is defined to mean the highly configured underlying data model that supports document creation and interpretation, collection of key document information, and commitments associated with executed documents. The core also includes advance workflow and knowledge management, risk avoidance and is the central location for security and user administration.

As used herein, the term “data model” is defined to mean a computerized collection of data organized by fields, records and files to allow rapid access. A field is an area in a fixed or known location in a record; a record is a collection of data items arranged for processing by a program; and a file is a related collection of records. In this case, each document is a record in the data model, and each file contains items such as the agreement record along with its linked (scanned in) agreement file, commitments, commitment triggering events, invoices and payments (if any). The data model can be relational, distributed, multidimensional or an object-oriented programming data model.

As used herein, the terms “contract”, “agreement” and “document” are used interchangeably. The term “document version” or “version” refers to a proposed document, i.e., one that has not yet been executed, signed or otherwise finalized. “Contract document,” as used herein, is defined to include both finalized documents and document drafts. “Report” as used herein means a formatted and organized presentation (either electronic or hardcopy) of data retrieved from a data model or query. A “commitment triggering event” is any event upon which a document commitment or right is conditioned. As used herein, the term “commitment” includes the term “right”.

As used herein, the term “analytics” is defined to mean the discovery and communication of meaningful patterns in data. Especially valuable in areas rich with recorded information, analytics relies on the simultaneous application of statistics, computer programming and operations research to quantify performance. Analytics often favors data visualization to communicate insight. “Analytics” applies to business data, to describe, predict, and improve business performance. Specifically, arenas within analytics include enterprise decision management, credit risk analysis, and fraud analytics.

As used herein, the term “ribbon” is defined to mean a set of toolbars placed on several tabs. A popular form of “ribbon” as their main interface, where large tabbed toolbars, filled with graphical buttons and other controls, are grouped by functionality. Such ribbons use tabs to expose different sets of controls, eliminating the need for many parallel toolbars.

As used herein, the term “data repository” is defined to mean a way to deploy a secondary tier of data storage that can comprise multiple, networked data storage technologies running on diverse operating systems, where data that no longer needs to be in primary storage is protected, classified according to captured metadata, processed, de-duplicated, and then purged, automatically, based on data service level objectives and requirements. In information repositories, data storage resources are virtualized as composite storage sets and operate as a federated environment.

The steps and/or actions of the method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium may be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium “Disk” and “disc”, as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure can be described with reference to flowchart illustrations and/or block diagrams of methods, apparatus (systems), and computer program products. It can be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an agreement or document draft including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the disclosure.

The core or underlying data model can be accessed by users through various methods as outlined herein. For example, the data model can be accessed through a portal, word ribbon, or through analytics and reporting. For clients and external users of the system, a portal may be preferred both for simplicity and for attractiveness when accessing the data model.

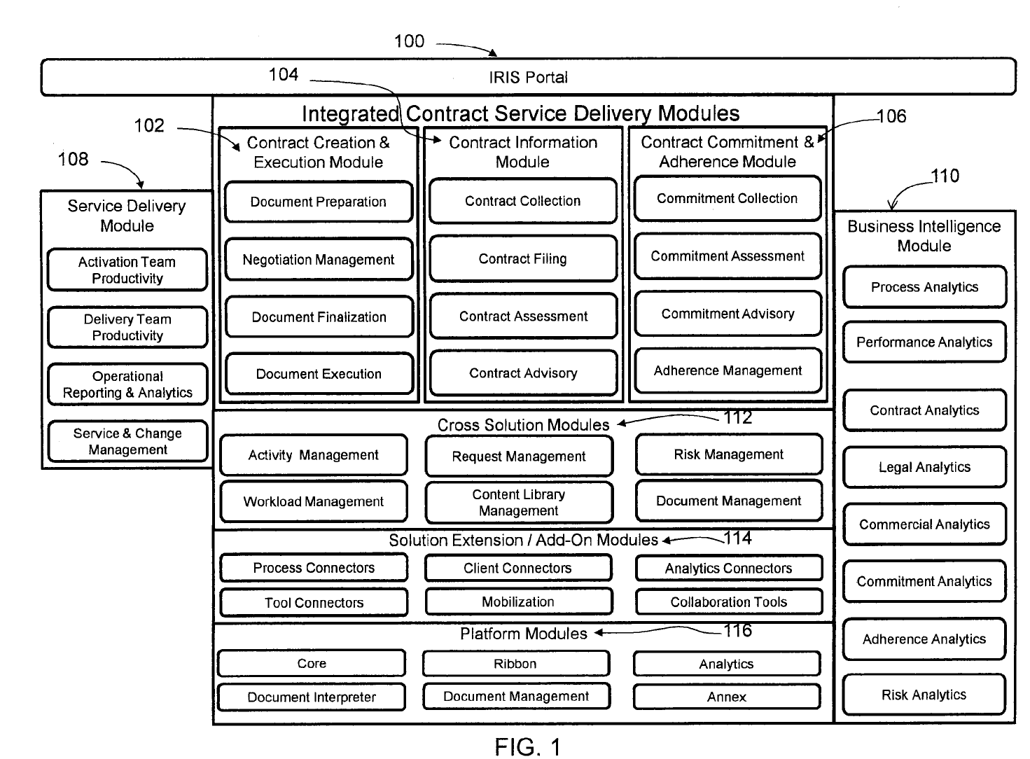

Referring to FIG. 1 and portal 100, the core or underlying data model comprises a plurality of modules configured to support integrated document delivery. The modules include document creation and execution modules 102, document information modules 104 and document commitment and adherence modules 106.

Document creation modules 102 are configured to manage document requests from a client, preparation of documents, management of negotiations of documents, interpret and extract versioned drafts, dynamically analyze negotiated drafts, and finalize documents and execute contract documents, and the like.

Contract information modules 104 are configured to collect executed contracts, contract filing, interpret and extract key metadata associated with the document, and monitor contracts, and the like.

Contract commitment and adherence modules 106 are configured to register document commitments, assess document commitments, monitor commitments, and manage commitment adherence, and the like.

Again, referring to FIG. 1 and portal 100, other modules that are part of the system of this disclosure include service delivery modules 108, business intelligence modules 110, cross solution modules 112, solution extension/add-on modules 114, and platform modules 116.

Service delivery modules 108 are configured to provide administration tools for activation and delivery team productivity in setup and deployment, operational reporting and analytics for visibility into internal operations, an overall view of client team productivity, and a view into and manage service and change requests, and the like.

The business intelligence modules 110 are configured for process analytics, performance analytics, contract analytics, legal analytics, commercial analytics, commitment analytics, adherence analytics, risk analytics and the like.

Cross solutions modules 112 are configured to manage submitted requests, their related process activities and related workload, interpret and extract document content and manage documents, assess risk and manage library content including templates, clauses, playbooks, and knowledge, and the like.

The solution extension/add-ons modules 114 are configured to provide connectivity to various commercially available tools, external processes, or specific client applications. The solution extension/add-on modules also provide mobilization and secure collaboration, and the like.

Platforms modules 116 are configured/deployed providing access to the various modules previously discussed.

The core contains a data model accessed through a network, or the platform modules defined in 116. Examples of suitable documents include those relating to all types of goods and services. In one embodiment, the data model of the present disclosure is designed to manage documents relating to intellectual property. Examples of such documents include: patent licenses, trademark licenses, copyright licenses, technology licenses, joint ventures, confidentiality agreements, research agreements, technical assistance agreements, technology or software evaluation agreements, engineering services agreements, technology testing agreements, manufacturing agreements, technology/product leasing agreements, technology/product sales agreements, technology process design agreements, consulting agreements etc. or any combination of the above.

The license agreements may be “one-way” or “two-way”, i.e., the intellectual property is transferred by one or both parties to the other. A confidentiality agreement (or commitment) may also be “one-way” or “two-way” (i.e., the commitment of confidentiality is on one party or is mutual), and may include a commitment to return or destroy documentation and/or samples of goods. There may also be a commitment to report evaluation results or use the information and/or sample in a specified manner.

Often the commitments in agreements, such intellectual property agreements, are conditioned on the occurrence of some other event, a commitment triggering event. The commitment to pay royalties, for example, may be triggered by events such as plant start-up, production of product or sales of product. The commitment to return or destroy documentation and/or samples of goods is often triggered by completion of evaluation or termination of the agreement. In one embodiment of the present disclosure, the data model included in the portal or network is designed to track specific commitments in relation to their due dates or corresponding commitment triggering events.

Data relating to each document can be organized and entered into the data model and modules according to predefined fields. Most documents share certain defining characteristics such as effective date, expiration date and contracting parties. These are of course suitable fields. Examples of other suitable fields are: some sort of “document identifier”, i.e., either a number or word (such as a party's name) or symbol used to distinguish that document record from others in the data model, agreement type, a field indicating whether or not the draft or document is in standard form, and a field indicating whether the document is related to another document in the data model either by its terms, subject matter or business unit, an identifier for the related agreement, and the relationship of the related agreement (e.g., supersedes, sublicense), a field indicating who or what group is responsible for the agreement.

Each field may be subdivided, for example with a “drop-down list,” to prompt the entry of certain details. For example, the “parties” field may be used to store data such as contact names, addresses, phone and fax numbers etc. In one embodiment, advanced table maintenance capability allows users to dynamically add and change selections for drop-down lists and other look-up tables for use in current and future agreements.

Data model schema employed to implement the system of this disclosure can include tables that drive the operation of the system, tables that support the completion of documents, tables that include rules and tables that control the layout and display of information in the user interface.

The data model and modules of the present disclosure can include fields relating to draft documents and to document commitments. Examples of such fields include, but are not limited to: draft document status, commitment type (categorization), some short verbal description of the commitment, commitment owner (what person, designated by name or title, is responsible for making sure the commitment is met), commitment status (whether the commitment is still outstanding, being carried out, expired etc.), commitment due date, units of measure, product group, billing number, etc.

The field for draft document status may be varied or subdivided to indicate when the first and/or subsequent draft was created, who created the draft, who requested the draft, whether the draft is being negotiated, whether the draft is being reviewed and by whom, whether the review is internal or external, whether the draft is being reviewed for execution and by whom, etc.

In one embodiment, the database and modules of the present disclosure also include fields relating to commitment triggering events. Examples of such fields include, but are not limited to, commitment triggering event type (some short verbal description of the commitment triggering event), commitment triggering event owner (what person, designated by name or title, is responsible for making sure the commitment triggering event is monitored), commitment status (whether the commitment triggering event, is still outstanding, being carried out, or has already been completed, etc.), commitment triggering event date, whether the event frequency and/or duration, and whether the whole commitment including event, invoice and payment is recurring or one-time.

In one embodiment, the database and modules of the present disclosure also include fields relating to evaluating the risk associated with a meta data item, clause or fall back position. Examples of such fields include, but are not limited to, a risk score being assisted to a fallback position or a risk score being an assigned to a meta data element that has exceed a certain amount or boundary.

This data model also includes the ability to exam the interaction between clauses or indeed meta data and includes the ability to suggest changes in language or meta data elements to reduce the current risk position.

It may be particularly useful to link all commitments and commitment triggering events to a responsible person and create fields such as: commitment owner, commitment assigned to, event assigned to, invoice assigned to, payment assigned to, etc.

In one embodiment of the present disclosure, the fields of the data model are used to generate reports that are in turn used to track, manage and administer various document commitments. Such reports may also include certain calculations using the field data, and they can be used for business forecasting and planning. The reports are either predefined or created as needed.

Optionally, the data model and modules can automatically remind designated people of commitments (or commitment triggering events) or important dates, and can interface directly or indirectly with other data models or networks. Examples of other data models include but are not limited to: telephone, e-mail, organizational directories, and collections of financial information, patent management systems, standard document template repositories, or any combination of the above. Examples of networks include but are not limited to: knowledge sharing platforms, portals, web-based systems, joint inter-company document systems, supply-chain systems, or any combination of the above.

Examples of reports include, but are not limited to, reports showing: financial commitments due, invoices sent, outstanding invoices, non-financial commitments due, commitment triggering events scheduled, documents expiring, commitments expiring, forecasts, accruals, customer history, active agreements, inactive agreements, cancelled agreements, pending agreements, corporate plan, stewardship etc. For example, the “documents expiring” report can be designed to alert interested parties far in advance of actual expiration dates to allow for sufficient time to negotiate renewal agreements.

The data model and modules of the present disclosure has extensive search capabilities. In one embodiment, there can be three main search screens; agreement search, full text search with an identified corpus, commitment search and docket search. The agreement search screen allows a user to search for agreements based on several fields including but not limited to: agreement number, agreement type, agreement sub-type, agreement summary, product line, intellectual property team, business unit, product group, parties, effective date, expiration date, attorney, paralegal, agreement requester, and agreement owner. An agreement summary is also full-text searchable and allows the user to search using the “and” and “or” Boolean operators. The commitment search screen in this embodiment allows a user to search for commitments or commitment triggering events that meet certain criteria such as belonging to certain agreement types, owner, due date, etc., using both commitment and agreement fields.

A docket search allows a user to search for individual components of a financial commitment and individual instances from a recurring commitment's schedule. There are several ways to search based on ownership (for example by product line, intellectual property team, business unit, agreement owner, commitment owner, event owner, invoice assigned to, payment assigned to, etc.). A user can also search for commitments and commitment triggering events based on status and due dates.

In addition to reporting, the data model of the present disclosure may be used to generate form documents such as invoices and correspondence. Invoicing can be linked to the commitment triggering event so that when the event occurs, the system automatically updates the invoice due date. Then when the invoice is actually generated, the payment due date is automatically updated and entered on the invoice template. For example, if a license agreement requires quarterly royalty payments and the amount of each payment is determined by the number of product pounds produced, then when the royalty payment commitment information is entered into the data model, a commitment triggering event, in this case a production report, is specified. The frequency for the report is entered and quarterly due dates are generated automatically. When the production report is received, the invoice due date is set. The payment due date is automatically adjusted and is based on when the invoice is actually generated. The invoice amount is automatically calculated based on the number of units produced as listed in the production report. When payment is received, the data model is updated accordingly. Thus, invoicing can be done directly from the system. Invoices are actually stored in the system and the invoice fields are used in reports.

The data model may in one embodiment automatically calculate certain financial terms such as interest, inflation, depreciation, taxes, currency conversions, add-on charges (for example for inspection or shipping) etc. Form documents include: form draft clauses or agreements, forms (for example summarizing the agreement and/or listing various reviewers) used for routing draft agreements for review and/or execution, form correspondence reminding parties or responsible persons of commitments (to make payment for example), form correspondence for renewing agreements, dunning letters, etc.

In one embodiment, the data model tracks invoice and payment data. This then enables businesses to forecast and report income on a business unit level, and enables financial planning on an agreement by agreement basis including multiple corporate or business plan years, forecasted and actual revenue per agreement or business unit and outlook for each year. The system also enables a business unit to perform stewardship by using reports to total income across all of their agreements and then to compare planned income vs. actual income received.

The data model of the present disclosure may optionally include features such as links to scanned documents (actual agreements and forms for example), large text fields for detailed notes, links to websites, web pages and e-mail addresses, the ability to track and store changes made in various fields, and the ability to store and update financial amounts in multiple types of currency using, for example, online linkage to exchange rates.

In one embodiment, the data model and modules of the present disclosure are designed so that each document is accessible by defined users. The users may be grouped such as by job, title, authority, business unit and/or project. In a preferred embodiment, the security is truly back-end so that people using the system have individual access to defined “views”. “Views” are the records that users are permitted to see. Write access is selectively granted using stored procedures on the data model back end. Groups of users are granted access (view and/or write access) only to records relevant to their business. The data model stores what business unit a user is in and all reports, queries and tables are accessed through the correct view. Thus users can create and update data solely in that portion of the data model to which they have access.

The methods of the present disclosure comprise at least the steps of drafting a document or receiving a draft document, storing data obtained from the draft in the document data model, after execution of the draft, storing data obtained from the resulting document in the same data model, and retrieving or generating from the data model a report of the document's outstanding commitments.

The drafting step may be as simple as entering basic information into the data model, or some other data model or form. The first “storing” step requires that at least one bit of information from the draft, for example the parties' names, be logged into the data model of the present disclosure. Typically other items will be entered at this time. For example, the attorney drafting the agreement or responsible for initially reviewing the draft proposed by the other party, the effective and expiration dates, the type of document, document or draft status, ownership of the agreement and security for the agreement record, etc. During this stage of the document lifecycle, the data model may be updated to reflect that routing/reviews has been conducted or modifications have been made.

After the draft document is executed by all parties, more detailed information will be entered into the data model, for example, specific licensing information, financial terms, forecasting of revenues and information relating to commitments. The report may be generated either automatically or using a unique field search and the report may or may not be printed. As discussed above, reports are used to manage the data model documents and their commitments; therefore, they are typically analyzed for decision making purposes. This analysis may be done automatically, for example using software that interfaces with the data model. Likewise the “decision making” and any action taken as a result, may be done automatically, for example by automatically generating (and perhaps sending) an invoice. Once commitments are met (or not), the data model can be updated (again, this can be done automatically), for example, to reflect what action was taken and whether other commitments remain outstanding.

Once all of an agreement's commitments are met or have expired, the data model is updated (either manually or automatically) to reflect that the agreement has expired. At that time, the agreement record can be archived or set for archive at a later date. Reports can be generated to remind interested parties that the agreement is set to expire so that it may be renewed if necessary. Form letters or memos can be created and generated to facilitate this process.

In one preferred embodiment, a system for workflow management during the provision of services to a client is provided. The system comprises: a portal or network selectively accessible by a plurality of users involved in the provision of services; a data model, accessible via the portal or network, the data model allowing controlled access by the plurality of users and storing data related to the client; and a user interface that provides access to the data model for the plurality of users, including the ability to obtain documents generated during the provision of services. The data model comprises a plurality of modules configured for integrated document delivery. The modules comprise: document creation and execution modules configured to manage document requests from a client, preparation of documents, management of negotiations of documents, interpret and extract versioned drafts, dynamically analyze negotiated drafts, and finalize documents and execute documents; document information modules configured to collect executed documents, file documents, interpret and extract key metadata associated with the document, and monitor documents; and document commitment and adherence modules configured to register document commitments, assess document commitments, monitor commitments, and manage commitment adherence.

The data model can further comprise service delivery modules. The service delivery modules are configured to provide administration tools for activation and delivery team productivity in setup and deployment, operational reporting and analytics for visibility into internal operations, an overall view of client team productivity, and a view into and manage service and change requests.

The data model can further comprise business intelligence modules. The business intelligence modules are configured for process analytics, performance analytics, contract analytics, legal analytics commercial analytics, commitment analytics, adherence analytics and risk analytics.

The data model can further comprise cross solution modules. The cross solution modules are configured to manage submitted requests, their related process activities and related workload, interpret and extract document content and manage documents, assess risk and manage library content including templates, clauses, playbooks, and knowledge.

The data model can further comprise solution extension/add-on modules. The solution extension/add-on modules are configured to provide connectivity to various commercially available tools, external processes, or specific client applications. The solution extension/add-on modules are further configured to provide mobilization and secure collaboration.

The services provided to a client include legal services. The services provided can include documents. The documents are selected from confidentiality documents, software licenses, technology licenses, lease documents, trading documents and service documents. In an embodiment, the documents are licenses.

The data model comprises data obtained from documents. The data is organized into fields comprising: draft document status, document identifier, document type, effective date, and expiration date; and a field comprising commitment type, owner, and status or due date. The system is capable of generating reports based on the data model. The reports are obtainable through search of the fields. The data model is selectively accessible by a plurality of users. The fields can further comprise: commitment triggering event, royalty basis, invoice due date, payment due date, payment received date, payment schedule, tax, currency and invoice status.

The draft document status field indicates whether a document is being reviewed, negotiated and/or executed. The commitment type field is substantially defined as training, meeting, shipping, payment, receipt of payment, reporting, start-up, secrecy, restricted use, maintenance or technology transfer.

A user's access to one or more parts of the data model is governed by authentication and entitlement logic. An example of this entitlement logic can include contract type, user's job description, user's title, user's business unit, and/or user's authority level.

The data model can further comprise standard document forms or clauses. The data model can further comprise standard invoice forms or standard correspondence. The data model is capable of using its data to generate invoices and correspondence.

The user interface includes a displayable screen including: a phase navigation bar depicting, in iconic form, the data associated with the services; and a document tree depicting, in a hierarchical fashion, the documents automatically generated by the system in relation to the services. The selection of an element in the phase navigation bar and document tree presents the user with further detailed information. The user interface further includes, in response to a user selection of a document from the document tree, a display of the document.

The system monitors the ordering of workflow tasks so as to assure that completion of a required task is accomplished prior to initiation of any subsequent tasks that rely on data generated by the required task. The system automatically notifies at least one user of the services of the completion of required tasks.

In another preferred embodiment, a method for workflow management during the provision of services to a client is provided. The method comprises: providing a portal or network selectively accessible by a plurality of users involved in the provision of services; creating a data model, accessible via the portal or network, the data model allowing controlled access by the plurality of users and storing data related to the client; and providing access to the data model for the plurality of users via a user interface, including the ability to obtain documents generated during the provision of services. The data model comprises a plurality of modules configured for integrated document delivery. The modules comprise: document creation and execution modules configured to manage document requests from a client, preparation of documents, management of negotiations of documents, interpret and extract versioned drafts, dynamically analyze negotiated drafts and finalize documents and execute documents; document information modules configured to collect executed documents, file documents, interpret and extract key metadata associated with the document, and monitor documents; and document commitment and adherence modules configured to register document commitments, assess document commitments, monitor commitments, and manage commitment adherence.

The method can further comprise: drafting a document or receiving a draft document; routing the draft document to one or more users for review, negotiation and/or execution; storing review, negotiation and/or execution data in the data model; accessing the review, negotiation and/or execution data in the data model by the one or more users; and retrieving from the data model a report on the document. The report includes status of the document and commitments incurred under the document.

The method can further comprise the steps of analyzing the report to determine which, if any, of the commitments should be acted upon; deciding, based on the analysis, whether to act upon one or more of the commitments; either making or receiving payment based on the analysis; updating the data model to reflect the payment or receipt of payment; obtaining from the data model an invoice or payment letter wherein the invoice or payment letter is generated automatically using the stored data; and sending the invoice or payment letter; and updating the data model to reflect that payment was made or to reflect receipt of payment.

The data model can further comprise service delivery modules. The service delivery modules are configured to provide administration tools for activation and delivery team productivity in setup and deployment, operational reporting and analytics for visibility into internal operations, an overall view of client team productivity, and a view into and manage service and change requests.

The data model can further comprise business intelligence modules. The business intelligence modules are configured for process analytics, performance analytics, contract analytics, legal analytics, commercial analytics, commitment analytics, adherence analytics and risk analytics.

The data model can further comprise cross solution modules. The cross solution modules are configured to manage submitted requests, their related process activities and related workload, interpret and extract document content and manage documents, assess risk and manage library content including templates, clauses, playbooks, and knowledge.

The data model can further comprise solution extension/add-on modules. The solution extension/add-on modules are configured to provide connectivity to various commercially available tools, external processes, or specific client applications. The solution extension/add-on modules are further configured to provide mobilization and secure collaboration.

The services provided to a client include legal services. The services provided can include documents. The documents are selected from confidentiality documents, software licenses, technology licenses, lease documents, trading documents and service documents. In an embodiment, the documents are licenses.

The data model comprises data obtained from documents. The data is organized into fields comprising of, but not limited to, draft document status, document identifier, document type, effective date, and expiration date; and a field comprising commitment type, owner, and status or due date. The method is capable of generating reports based on the data model. The reports are obtainable through search of the fields. The data model is selectively accessible by a plurality of users. The fields can further comprise at least one selected from: commitment triggering event, royalty basis, and invoice due date, payment due date, payment received date, payment schedule, tax, currency and invoice status.

The draft document status field indicates whether a document is being reviewed, negotiated and/or executed. The commitment type field is substantially defined as training, meeting, shipping, payment, receipt of payment, reporting, start-up, secrecy, restricted use, maintenance or technology transfer.

A user's access to one or more parts of the data model is governed by authentication and entitlement logic. An example of this entitlement logic can be the user's contract type, user's job description, user's title, user's business unit, and/or user's authority level.

The reports are selected from: accrued revenue, commitments due, commitments owed, customer history, open invoice, depreciation, corporate plan, stewardship, implementation plan, payments requiring invoice, anticipated payments, audit, pending documents, active documents and expiring documents.

The data model can further comprise standard document forms or clauses. The data model can further comprise standard invoice forms or standard correspondence. The data model is capable of using its data to generate invoices and correspondence.

The user interface includes a displayable screen including: a phase navigation bar depicting, in iconic form, the data associated with the services; and a document tree depicting, in a hierarchical fashion, the documents automatically generated by the method in relation to the services. The selection of an element in the phase navigation bar and document tree presents the user with further detailed information. The user interface further includes, in response to a user selection of a document from the document tree, a display of the document.

The method monitors the ordering of workflow tasks so as to assure that completion of a required task is accomplished prior to initiation of any subsequent tasks that rely on data generated by the required task. The method automatically notifies at least one user of the services of the completion of required tasks.

Where methods described above indicate certain events occurring in certain orders, the ordering of certain events can be modified. Moreover, while a process depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on”.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for workflow management during the provision of services to a client, said system comprising:
a portal or network selectively accessible by a plurality of users involved in the provision of services;
a data model, accessible via said portal or network, said data model allowing controlled access by the plurality of users and storing data related to the client; and
a user interface that provides access to said data model for said plurality of users, including the ability to obtain documents generated during the provision of services;
wherein said data model comprises a plurality of modules configured for integrated document delivery, said modules comprising:
document creation and execution modules configured to manage document requests from a client, preparation of documents, management of negotiations of documents, interpret and extract versioned drafts, dynamically analyze negotiated drafts and finalize documents and execute documents;
document information modules configured to collect executed documents, file documents, interpret and extract key metadata associated with the document, and monitor documents; and
document commitment and adherence modules configured to register document commitments, assess document commitments, monitor commitments, and manage commitment adherence.

2. The system of claim 1, wherein the data model further comprises service delivery modules, said service delivery modules configured to provide administration tools for activation and delivery team productivity in setup and deployment, operational reporting and analytics for visibility into internal operations, an overall view of client team productivity, and a view into and manage service and change requests.

3. The system of claim 1, wherein the data model further comprises business intelligence modules, said business intelligence modules are configured for process analytics, performance analytics, document analytics, commercial analytics, commitment analytics, adherence analytics, risk analytics, and substantive legal analytics.

4. The system of claim 1, wherein the data model further comprises cross solution modules, said cross solution modules configured to manage submitted requests, their related process activities and related workload, interpret and extract document content and manage documents, assess risk and manage library content including templates, clauses, playbooks, and knowledge.

5. The system of claim 4, wherein the data model further comprises solution extension/add-on modules, said solution extension/add-on modules configured to provide connectivity to various commercially available tools, external processes, or specific client applications.

6. The system of claim 5, wherein the solution extension/add-on modules are further configured to provide mobilization and secure collaboration.

7. The system of claim 1, wherein the data model further comprises platform modules, said platform modules configured to manage users and for remote access, globalization and document data engines.

8. The system of claim 1, wherein the services provided include legal services and/or documents.

9. The system of claim 8, wherein the documents are selected from the group including but not limited to: confidentiality documents, licenses, software licenses, technology licenses, lease documents, trading documents and service documents.

10. The system of claim 1, wherein the data model comprises data obtained from documents, said data organized into fields comprising: draft document status, document identifier, document type, effective date, and expiration date; and a field comprising commitment type, owner, status or due date; said system capable of generating reports based on said data model, said reports obtainable through search of said fields; and said data model being selectively accessible by a plurality of users.

11. The system of claim 10, wherein said fields further comprise at least one selected from the group consisting of: commitment triggering event, royalty basis, invoice due date, payment due date, payment received date, payment schedule, tax, currency and invoice status.

12. The system of claim 10, wherein said draft document status field indicates whether a document is being reviewed, negotiated and/or executed.

13. The system of claim 10, wherein said commitment type field is substantially defined as training, meeting, shipping, payment, receipt of payment, reporting, start-up, secrecy, restricted use, maintenance or technology transfer.

14. The system of claim 1, wherein a user's access to one or more parts of said data model is based on contract type, user's job description, user's title, user's business unit, and/or user's authority level.

15. The system of claim 10, wherein said reports are selected from the group consisting of: accrued revenue, commitments due, commitments owed, customer history, open invoice, depreciation, corporate plan, stewardship, implementation plan, payments requiring invoice, anticipated payments, audit, pending documents, active documents and expiring documents.

16. The system of claim 1, wherein said data model further comprises standard document forms, standard document clauses, standard invoice forms and/or standard correspondence.

17. The system of claim 1, wherein said data model is capable of using its data to generate invoices and correspondence.

18. The system of claim 1, wherein said user interface includes a displayable screen including: a phase navigation bar depicting, in iconic form, the data associated with the services; and a document tree depicting, in a hierarchical fashion, the documents automatically generated by the system in relation to the services, wherein selection of an element in the phase navigation bar and document tree presents the user with further detailed information.

19. The system of claim 1, wherein said user interface further includes, in response to a user selection of a document from said document tree, a display of said document.

20. The system of claim 1, wherein said system monitors the ordering of workflow tasks so as to assure that completion of a required task is accomplished prior to initiation of any subsequent tasks that rely on data generated by the required task.

21. The system of claim 1, wherein said system automatically notifies at least one user of the services of the completion of required tasks.

22. A method for workflow management during the provision of services to a client, said method comprising:
providing a portal or network selectively accessible by a plurality of users involved in the provision of services;
creating a data model, accessible via said portal or network, said data model allowing controlled access by the plurality of users and storing data related to the client; and
providing access to said data model for said plurality of users via a user interface, including the ability to obtain documents generated during the provision of services;
wherein said data model comprises a plurality of modules configured for integrated document delivery, said modules comprising:
document creation and execution modules configured to manage document requests from a client, preparation of documents, management of negotiations of documents, interpret and extract versioned drafts, dynamically analyze negotiated drafts and finalize documents and execute documents;
document information modules configured to collect executed documents, file documents, interpret and extract key metadata associated with the document, and monitor documents; and
document commitment and adherence modules configured to register document commitments, assess document commitments, monitor commitments, and manage commitment adherence.
